(19) United States
(12) Patent Application Publication
(10) Pub. No.: US 2006/0109257 A1
(43) Pub. Date: May 25, 2006

(54) Writing tablet

(76) Inventor: Emilio Ambasz, Buenos Aires (AR)

Correspondence Address: BAKER & BOTTS, 30 ROCKEFELLER PLAZA, NEW YORK, NY, 10112, US

(21) Appl. No.: 11/252,179

(22) Filed: Oct. 17, 2005

Related U.S. Application Data
(60) Provisional application No. 60/619,742, filed on Oct. 18, 2004.

(51) Int. Cl. G09G 5/00

(52) U.S. Cl. 345/173

(57) ABSTRACT

A movable writing tablet for a chair comprising of a tablet mounted to a tablet support. A double rotating hinge connects to the tablet and support on one end, and is connected to a support block on the other end. The other end of the support block is connectable to a stack chair. The double rotating hinge enables the writing tablet to rotate about a horizontal and a vertical plane such that it can be positioned in the open or closed position. The tablet can be positioned in a vertical position adjacent to the support block allowing vertical stacking of chairs equipped with similar writing tablets. When the writing tablet is in the closed position it enables vertical stacking of chairs by automatically shifting from its vertical to a tilted position, allowing the tablets to stack on top of each other. Vertical stacking of two or more chairs allows their associated writing tablets to “nest” one on top of the other.

### PRIORITY AND RELATED APPLICATION

This application claims the benefit of U.S. Provisional Application No. 60/619,742, filed Oct. 18, 2004, which is hereby incorporated by reference in its entirety.

### FIELD OF INVENTION

The present invention relates to a movable writing tablet for a stackable chair.

### BACKGROUND OF THE INVENTION

Stackable chairs are widely used in institutional and commercial settings of all sorts, such as meeting and conference rooms, auditoriums, multi-purpose assembly halls, and gymnasiums that can be temporarily converted to auditoriums. Stackable chairs occupy a small volume for storage, thus making space in a room available for other purposes.

Writing tablets have been installed on chairs, but even if they are adjustable in some manner they do not allow for the writing tablet to be positioned such that chairs equipped with similar writing tablets can be stacked together for storage. Traditional writing tablets encompass a multitude of parts and are not designed for enabling quick and easy closing of the tablet.

There is a need to provide a movable writing tablet that can be positioned such that chairs equipped with similar writing tablets can be stacked. There is a further need for such a writing tablet that has minimal parts, and can be quickly moved from the open to closed position automatically by applying minimal movement or force to the tablet.

### SUMMARY OF THE INVENTION

An object of the present invention is to provide a writing tablet for a chair that easily drops from an open, or in-use position, to a closed, or storage position. The writing tablet includes a mechanism that allows the writing tablet to drop automatically to its lower and closed position whenever someone rises quickly from the chair on which the writing tablet is attached, as in the case of a rapid exit.

It is a further object of the present invention to provide a writing tablet that when in its closed position, the mechanism allows other chairs equipped with a similar writing tablet in its closed position to stack vertically, one on top of the other. The writing tablet mechanism enables vertical stacking by letting the writing tablet shift automatically from its vertical to a tilted position, allowing the tablets to stack on top of each other.

### BRIEF DESCRIPTION OF THE DRAWINGS

FIG. 1 is a side pictorial view of one embodiment of the tablet of the present invention in the open position.

FIG. 2 is a side elevation view of the embodiment.

FIG. 3 is a top plan view of the embodiment in the open position.

FIG. 4 is a side elevation view of the embodiment in the closed position.

FIG. 5 is a front elevation view of the embodiment in the closed position.

FIG. 6 is a side sectional view of the embodiment.

FIG. 7A is a side elevation view of the support block of the embodiment.

FIG. 7B is a front sectional view of the support block of the embodiment.

FIG. 7C is side sectional view of the double rotating hinge of the embodiment.

FIG. 7D is front sectional view of the double rotating hinge the embodiment.

FIG. 7E is top plan view of the double rotating hinge of the embodiment.

FIG. 8A is side sectional view of the writing tablet support of the embodiment.

FIG. 8B is a bottom sectional view of the writing tablet support of the embodiment.

FIG. 9 is a top plan view of the writing tablet of the embodiment.

FIG. 10A is a front elevation view of the writing tablet attached to a stackable chair.

FIG. 10B is a front elevation view of a number of stacked chairs each equipped with the writing tablet.

FIG. 11A is a side elevation view of the writing tablet attached to a stackable chair.

FIG. 11B is a side sectional view of the writing tablet attached to a stackable chair.

FIG. 11C is a side elevation view of a number of stacked chairs each equipped with the writing tablet.

### DETAILED DESCRIPTION

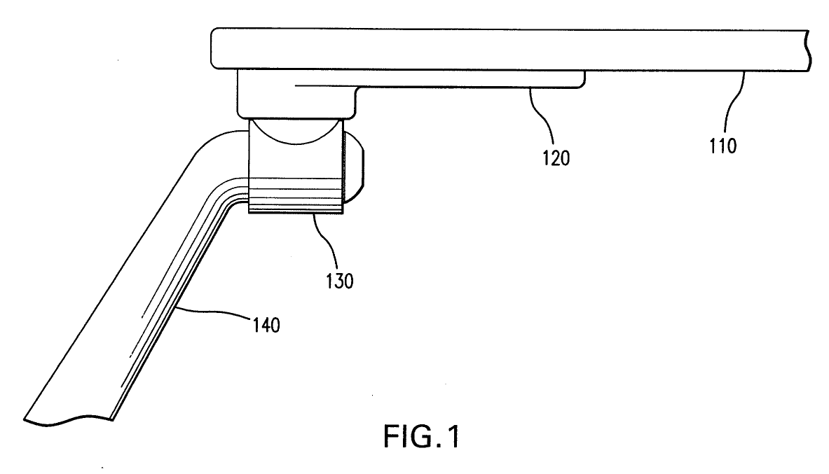

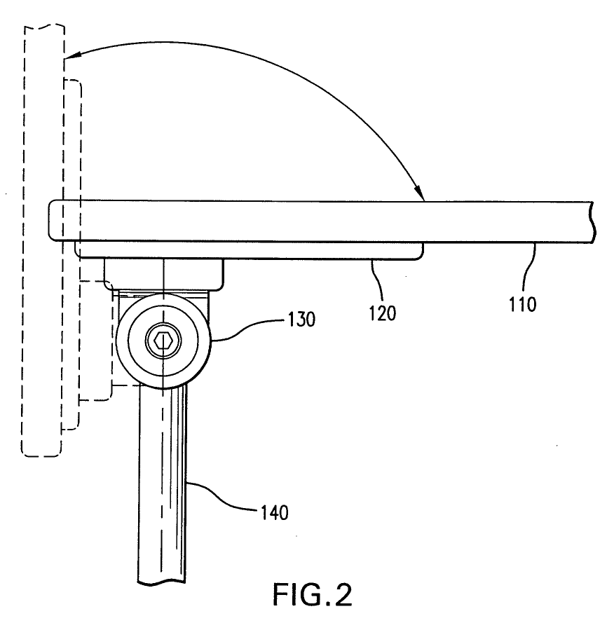

The embodiment of the present invention shown in FIG. 1 is a movable writing tablet that is attachable to a chair. The writing tablet in FIG. 1 is shown in the open, or in-use, position, and the bottom side of the writing tablet 110 is attached to a tablet support 120. The tablet support 120 is connected to a double rotating hinge 130. The double rotating hinge 130 allows the writing tablet to be positioned on the horizontal plane, as shown in FIG. 1, or rotate about a horizontal and vertical axis and positioned on the vertical plane, as shown in FIGS. 2, 3, 4 and 5. Referring to FIG. 1, the other end of the double rotating hinge 130 is connected to a support block 140. The other end of the support block 140 is attachable to chair, such that the writing tablet 110 can be positioned in the open, or horizontal, position in front of a person seated in the chair.

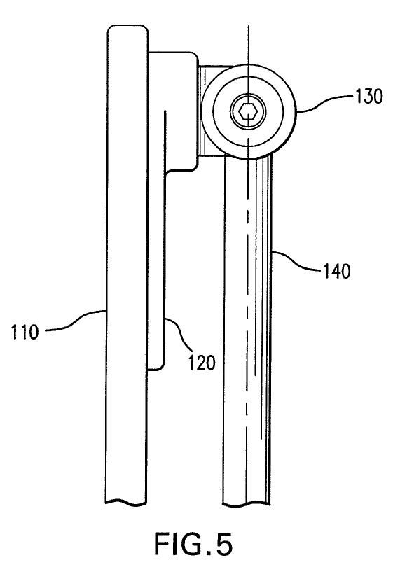

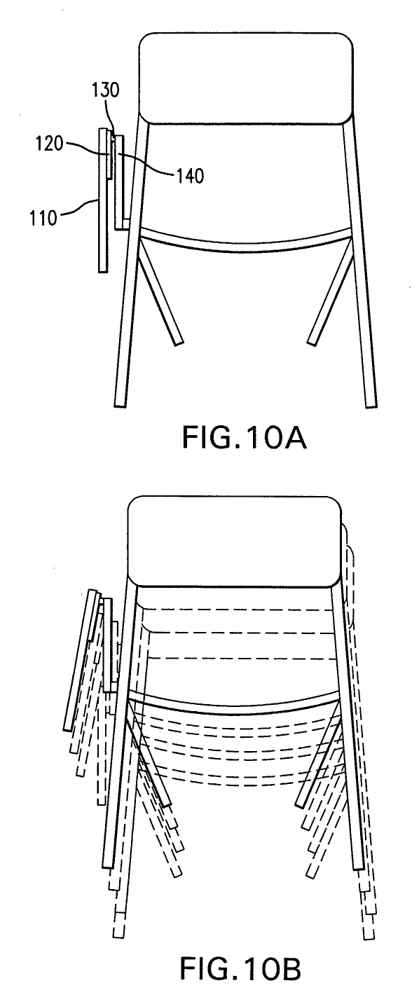

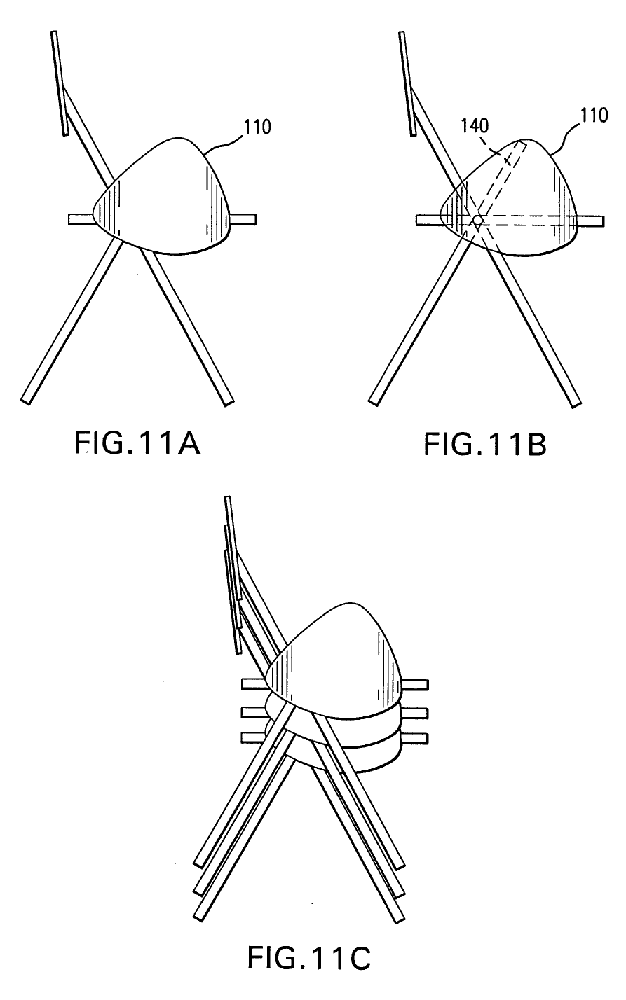

FIG. 2 shows a front view of the writing tablet 110. The double rotating hinge 130 allows the writing tablet 110 to rotate about a vertical axis. The double rotating hinge 130 also allows the writing tablet 110 to rotate about a horizontal axis, as shown in FIG. 5, such that the writing tablet 110 can be positioned in the closed, or storage position. When the tablet 110 is placed in the storage position as shown in FIG. 5, other chairs equipped with a similar writing tablet can stack vertically, one on top of the other when also placed in the closed position. The writing tablet 110, double rotating hinge 130, and support block 140 enables vertical stacking of chairs by enabling the writing tablet 110 to shift automatically from its vertical to a tilted position, allowing the tablets to stack on top of each other, as shown in FIGS. 10B and 11C.

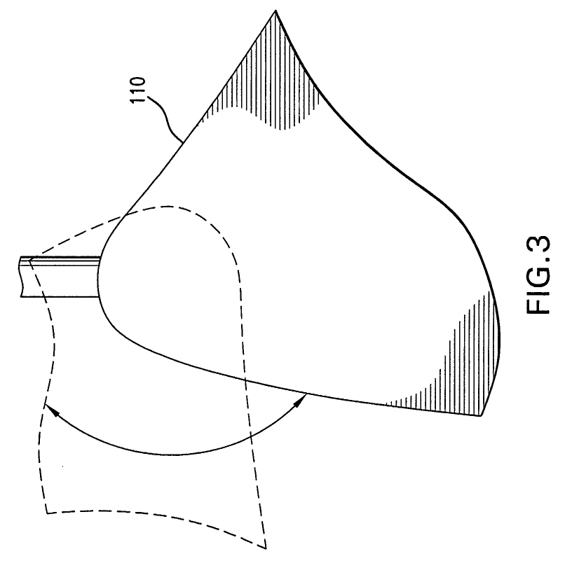

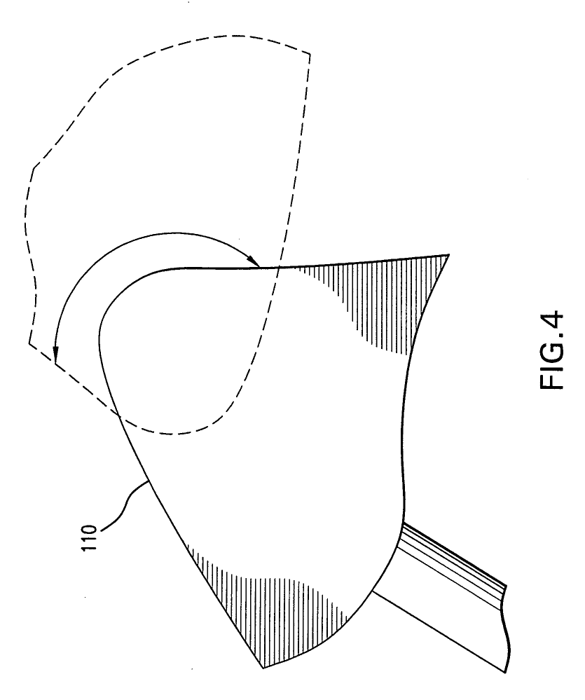

When a person seated in a chair installed with the writing tablet 110 in the open position wishes to exit the chair, FIG. 3 shows that the tablet 110 can be rotated on a horizontal plane, about a vertical axis, before the tablet 110 is tilted vertically and allowed to drop to its closed position. Once rotated on the horizontal plane in a direction away from the person seated in the chair, the writing tablet 110 can be turned on a vertical plane, about a horizontal axis, and then allowed to drop to its closed position, as shown in FIG. 4. FIG. 5 shows a front view of the writing tablet in the closed and vertical position.

A person exiting the chair that is equipped with the writing tablet 110 can close the tablet 110 by either pushing up on the tablet, as would occur in a rapid exit, or by pushing the tablet away. The double rotating hinge 130 enables the writing tablet 110 to travel from the open position to the closed position by applying an upward vertical force, a outward horizontal force, or any combination thereof. This allows, for example, a person to close the tablet by exiting the chair in any manner suitable to the particular person seated in the chair. And any forces applied to the tablet as the person exits the chair will cause the tablet to automatically travel from the open position to the closed position.

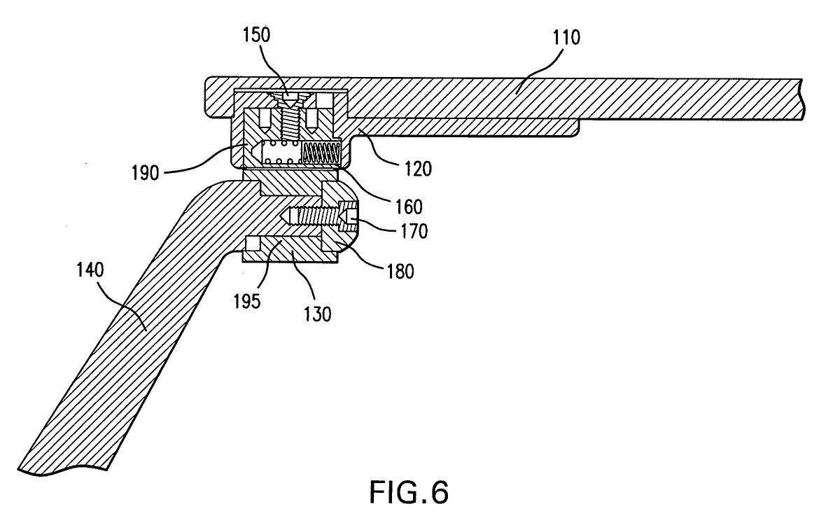

FIG. 6 shows a side sectional view of the writing tablet. The writing tablet 110 is shown in the open position, positioned on the horizontal plane. The writing tablet 110 is mounted to a tablet support 120, which contains a first cavity 190. One end of a double rotating hinge 130 is mounted in the first cavity 190 and attaches to the tablet support 120 with a restraining screw 150. The writing tablet 110 is held in the open position by a position pin 160 and spring 165. The other end of the double rotating hinge 130 contains a second cavity 195. A support block 140 is mounted in the second cavity 195 of the double rotating hinge 130 and is fastened by a blocking screw 170. A terminal cap screw 180 is installed over the blocking screw 170.

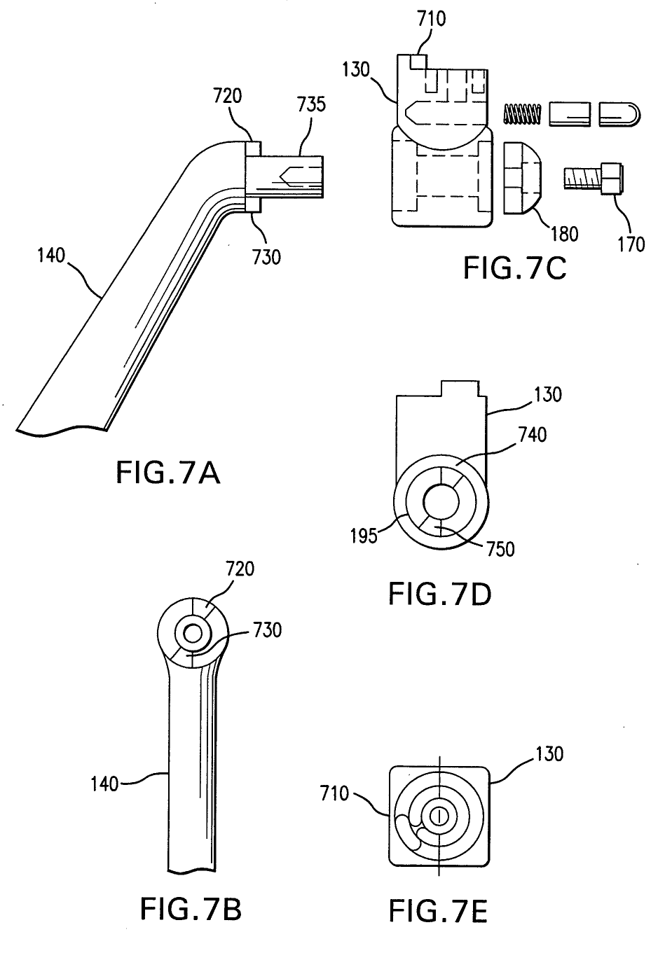

FIG. 7A shows a side elevation view of the support block 140, and FIG. 7B is a front sectional view of the support block 140. Referring to FIG. 7A, the support block 140 has a first end 735 and two blocking studs known as a second blocking stud 720 and a third blocking stud 730. The first end 735 of support block 140 inserts into the second cavity 195 of the double rotating hinge 130, shown in FIG. 7D. A first counter blocking stud 740 and second counter blocking stud 750, shown in FIG. 7D, are located inside the second cavity 195 of the double rotating hinge 130. The second blocking stud 720 and third blocking stud 730 make contact with the first counter blocking stud 740 and second counter blocking stud 750, such that the double rotating hinge 130 is able to rotate about a horizontal axis when the support block 140 is attached to the double rotating hinge 130. The blocking studs and counter blocking studs are used to limit the range of motion of the writing tablet when the blocking studs and counter blocking studs make contact with each other.

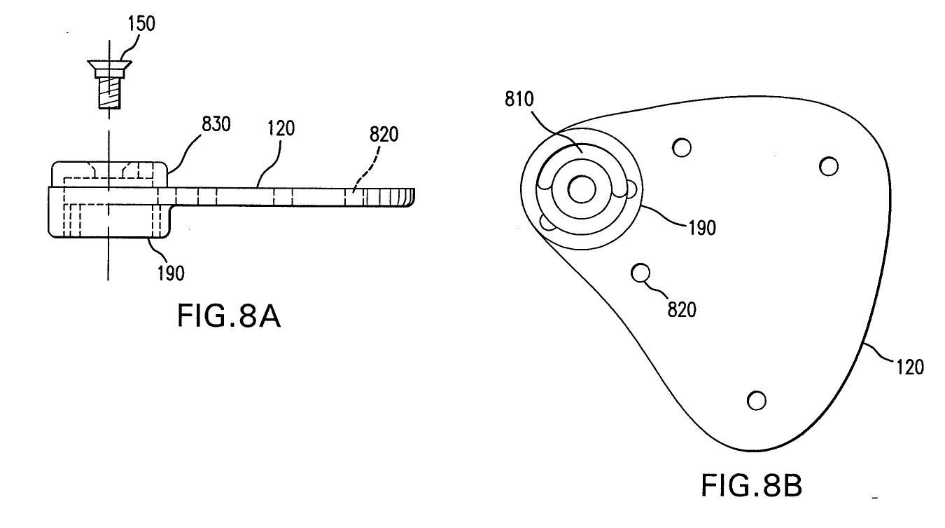

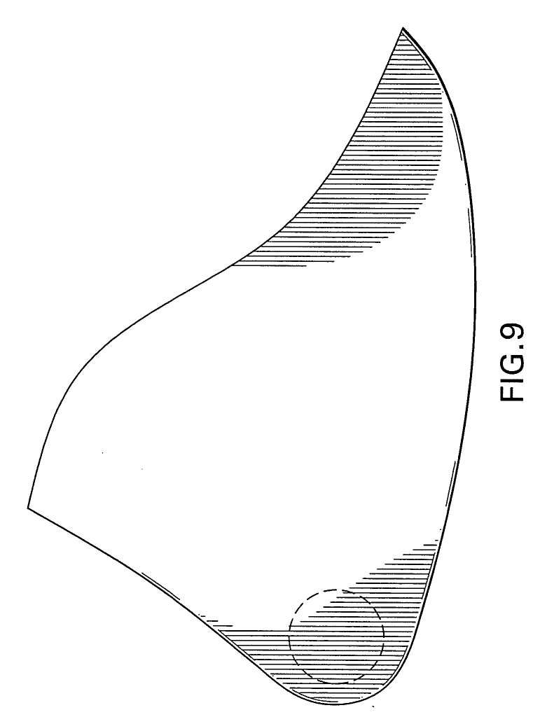

FIG. 7C shows a side sectional view of the double rotating hinge 130 with a first blocking stud 710. The first blocking stud 710 is inserted into the first cavity 190 of the tablet support 120 shown in FIG. 6. FIG. 8B shows a bottom sectional view of the writing tablet support 120 with the first cavity 190 and a slotted hole 810. The double rotating hinge 130 is inserted into the first cavity 190 such that the first blocking stud 710 is inserted into the slotted hole 810. The blocking stud 710 and slotted hole 810 arrangement allows the writing tablet 130 to rotate about a vertical axis, and limits the movement of the writing tablet 130 to a position corresponding to the length of the slotted hole 810. FIG. 7E shows a top plan view of the double rotating hinge 130 and the first blocking stud 710.

FIG. 8A shows a side sectional view of the writing tablet support 120, the restraining screw 150, and phantom lines showing the outline of the first cavity 190. A writing tablet coupling 830 is integrated into the tablet support 120, and is used to locate the writing tablet 130 onto the tablet support 120. The writing tablet 130 is fastened to the tablet support with fasteners, preferably screws, that are positioned through the screw holes 820 located in the tablet support 120 and shown in FIG. 8B.

FIG. 10A is a front elevation view of the writing tablet 110, double rotating hinge 130, tablet support 120, and support block 140 attached to a stackable chair. The writing tablet 110 connects to the tablet support 120, and the double rotating hinge 130 connected to the other side of the tablet support 120. The double rotating hinge 130 is connected to the support block 140, which is attached to a stackable chair. When the writing tablet 110 is in the closed position, as shown in FIG. 10A, chairs equipped with similar writing tablets can be vertically stacked as shown in FIG. 10B. The double rotating hinge 130 enables the writing tablet 110 to rotate about a vertical and horizontal axis such that it can be positioned adjacent to the support block 140. The horizontal and vertical positioning allows the writing tablet 110 to be positioned such that chairs equipped with similar writing tablets can be vertically stacked, as shown in FIGS. 10B and 11C.

FIG. 11A is a side elevation view of the writing tablet 110 and stackable chair. FIG. 11B is a side elevation view of the writing tablet 110 and stackable chair with phantom lines showing the support block 140. The writing tablet 110 in FIGS. 11A and 11B is shown in the closed position. When a second chair equipped with similar writing tablet is vertically stacked onto a first chair, the writing tablet of the second chair rotates at a slight angle—known as a tilted position—such that the writing tablet is positioned on top of the first chair's writing tablet. Vertical stacking of two or more chairs allows their associated writing tablets to “nest” one on top of the other, as shown in FIG. 10B.

Those of ordinary skill in the art will appreciate that the foregoing discussion of certain embodiments and preferred embodiments are illustrative only, and does not limit the spirit and scope of the present invention, which is limited only by the claims set forth below.

I claim:

1. A movable writing tablet for a chair comprising:
a tablet support having a first side and a second side;
a tablet mounted to the first side of the tablet support;
a double rotating hinge having a first connection point and a second connection point, the second side of the tablet support being connected to the first connection point of the double rotating hinge; and
a support block having a first end and a second end, the first end of the support block being connected to the second connection point of the double rotating hinge and the second end of the support block being connected to the chair,
wherein the tablet is rotatable about a horizontal plane and a vertical plane.

2. The movable writing table according to claim 1, wherein the second side of the tablet support comprises a first cavity in which the first connection point of the double rotating hinge is received.

3. The movable writing tablet according to claim 2, wherein the first cavity in the second side of the tablet support comprises a slotted hole for providing a blockage area.

4. The movable writing tablet according to claim 3, wherein the first connection point of the double rotating hinge comprises a first blocking stud, wherein the first blocking stud is received in the slotted hole in the cavity contained in the second side of the tablet support.

5. The movable writing tablet according to claim 2, wherein the first connection point of the double rotating hinge is received in the cavity of the second side of the table support and attached to the table support by a restraining screw, spring and position pin.

6. The movable writing tablet according to claim 1, wherein the second connection point of the double rotating hinge comprises a second cavity in which the first end of the support block is received.

7. The movable writing tablet according to claim 6, wherein the second cavity in the second connection point of the double rotating hinge comprises a first and a second counter-blocking stud.

8. The movable writing tablet according to claim 7, wherein the first end of the support block comprises a second and a third blocking stud, and is received in the second cavity of the second connection point of the double rotating hinge, and is attached to the double rotating hinge by a blocking screw.

9. The movable writing tablet according to claim 1, wherein the tablet can be rotated to an open position, wherein the tablet is positioned on the horizontal plane.

10. The movable writing tablet according to claim 1, wherein the tablet can be rotated to a closed position, wherein the tablet is positioned on the vertical plane.

11. A movable writing tablet for a chair comprising:
a tablet having a tablet support;
a double rotating hinge having a first connection point and a second connection point, the tablet support being connected to the first connection point of the double rotating hinge; and
a support block having a first end and a second end, the first end of the support block being connected to the second connection point of the double rotating hinge and the second end of the support block being connected to a first chair,
wherein the tablet is rotatable about a horizontal plane and a vertical plane such that the tablet can be positioned in a vertical position adjacent to the support block allowing a second chair equipped with a similar writing tablets to be vertically stacked on said first chair.

12. The movable writing tablet according to claim 11, wherein the writing tablet automatically rotates from the vertical position to a tilted position when the second chair is vertically stacked on said first chair.
